(19) United States
(12) Patent Application Publication
(10) Pub. No.: US 2016/0005366 A1
(43) Pub. Date: Jan. 7, 2016

(54) LIQUID CRYSTAL DISPLAY (LCD) AND ACTIVE SHUTTER THREE-DIMENSIONAL (3D) LCD DISPLAY APPARATUS

(71) Applicant: SHENZHEN CHINA STAR OPTOELECTRONICS TECHNOLOGY CO., LTD., Shenzhen, Guangdong (CN)

(72) Inventors: Bin Fang, Shenzhen (CN); Chihming Yang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 14/360,631

(22) PCT Filed: Mar. 11, 2014
(86) PCT No.: PCT/CN2014/073197

§ 371 Date: May 26, 2014

(30) Foreign Application Priority Data
Mar. 3, 2014 (CN) 201410075188.6

(51) Int. Cl. G09G 3/36; G02F 1/1362; G02B 27/22; G02F 1/1368

(52) U.S. Cl. CPC G09G 3/3614; G02F 1/1368; G02F 1/136286; G02B 27/22

(57) ABSTRACT

A LCD display panel and active shutter three-dimensional (3D) LCD display apparatus of the present invention are described. The LCD panel employs a frame amount value of “a”, a positive integer, including a plurality of frames constructs a frame set, the frame set includes at least one non-changed frame and at least one changed frame, and wherein when the LCD panel displays the non-changed frame, a plurality of polarities of pixel units keep constant, and when the LCD panel displays the changed frame, the polarities of pixel units of the LCD panel are changed. The present invention improves the image sticking phenomenon and the 3D image crosstalk.

### FIELD OF THE INVENTION

The present invention relates to a liquid crystal display (LCD) technique, and more particularly to a LCD display panel and an active shutter three-dimensional (3D) LCD display apparatus.

### BACKGROUND OF THE INVENTION

Conventionally, the active shutter 3D display technique is implemented by a LCD display having the higher refresh rate cooperated with and 3D shutter glass for constructing the 3D display. The glass function of the 3D shutter glass is performed by two LCD panels with the controllable switch devices. The liquid crystal layers of the LCD panels include black and white color statuses wherein the glass is in the white status having transparent color when the liquid crystal layer is not applied by power signal and the glass is in the black status having dark color when the liquid crystal layer is applied by power signal. Thus, one LCD panel receives left-eye image signal of the LCD display and the other LCD panel receives right-eye image signal of the LCD display. While the LCD display emits synchronous signal by a signal emission device, the LCD panels of the 3D shutter glass are synchronous and switched with the left-eye image signal and right-eye image signal.

One feature of liquid crystal molecule is that the behavior of liquid crystal molecule is damaged when the electrical field applied to the liquid crystal layer constant during a longer time interval. In other words, the liquid crystal molecule cannot be rotated by the electrical field change, resulting in different gray levels. Therefore, it is required to change the electrical field to invert the liquid crystal molecule in a predetermined time interval to avoid the damage of the liquid crystal molecule. Currently, there are many driving methods to implement of the inversion (e.g. polarity inversion) of the liquid crystal molecule, such as dot inversion, frame inversion, column inversion and row inversion driving methods.

The data signal transmitted in the data line employs the common voltage (Vcom) as reference voltage wherein the data signal include positive electrode data signal (+) higher than the common voltage and negative polarity data signal (−) lower than the common voltage. The positive polarity data signal is defined as the voltage higher than the common and the negative polarity data signal is defined as the voltage lower than the common voltage. When the same gray level value is indicated by the positive polarity data signal or the negative polarity data signal, the display status is identical theoretically.

When the active shutter 3D LCD display apparatus employs dot inversion driving method to drive the pixels of the panel, the pixel polarity of the liquid crystal is shown in FIG. 1. Frame 01 through frame 04 are four sequential frames in FIG. 1. The odd frames of the conventional LCD display are used to display left-eye image frame (or right-eye image frame) and the even frames of the conventional LCD display are used to display right-eye image frame (or left-eye image frame). For example, when the frame signals of the LCD display are higher gray level (e.g. white color status) of the left-eye image frame and the lower gray level (e.g. black color status) of the right-eye image frame, the positive polarity pixel (i.e. the pixel with positive polarity data signal) in the upper left corner of the frame 01 of FIG. 1 is used to display higher gray level signal, the negative polarity pixel (i.e. the pixel with negative polarity data signal) in the upper left corner of the frame 02 of FIG. 1 is used to display lower gray level signal, and the positive polarity pixel in the upper left corner of the frame 03 is used to display higher gray level signal. The lower gray level signal, either the positive polarity data signal or the negative polarity data signal, approaches the common voltage, and the higher gray level signal, either the positive polarity data signal or the negative polarity data signal, is far from the common voltage. In this case, the pixel of the LCD display is always the positive polarity pixel (positive polarity data signal) or in negative polarity pixel (negative polarity data signal), resulting in image sticking phenomenon.

When the active shutter 3D LCD display apparatus employs dot inversion driving method in two frames to drive the pixels of the panel, the pixel polarity of the liquid crystal is shown in FIG. 2. Frame 01 through frame 04 are four sequential frames in FIG. 2. When the frame signals of the LCD display are higher gray level signal of the left-eye image frame and the lower gray level signal of the right-eye image frame, the positive polarity pixel in the upper left corner of the frame 01 of FIG. 2 is used to display higher gray level signal, the positive polarity pixel in the upper left corner of the frame 02 of FIG. 2 is used to display lower gray level signal, the negative polarity pixel in the upper left corner of the frame 03 is used to display higher gray level signal, and the negative polarity pixel in the upper left corner of the frame 04 is used to display lower gray level signal. In this case, each pixel of the LCD display shows the higher gray level signal of the positive polarity data signal and the negative gray level signal of the positive polarity data signal to avoid the image sticking phenomenon.

However, during the display process of the LCD panel in FIG. 2, frame 02 and frame 04 are for right-eye image frame and frame 01 and frame 03 are for left-eye image frame. Since the frames 01 and 02 are data signal with the same polarity, it is required to re-allocate the electric charges of the pixels when the LCD display is operated by the data signal so that the brightness of the frame 02 is greater than that of the frame 01 and the brightness of the frame 04 is greater than that of the frame 03, i.e. the brightness of the right-eye image frame is greater than that of the left-eye image frame. Therefore, the 3D image crosstalk phenomenon of the LCD display occurs and the display quality of the LCD panel is downgraded.

Consequently, there is a need to develop an active shutter 3D LCD display apparatus to solve the aforementioned problem.

### SUMMARY OF THE INVENTION

One objective of the present invention is to provide a LCD display panel and an active shutter 3D LCD display apparatus to avoid the image sticking phenomenon and the 3D image crosstalk to solve the problem of the image sticking and the 3D image crosstalk.

According to the above objective, the present invention sets forth a LCD display panel and an active shutter 3D LCD display apparatus. In one embodiment, the liquid crystal display (LCD) panel, comprising:

a plurality of parallel data lines; and

a plurality of parallel scan lines wherein the data lines and the scan lines are vertically arranged in an intersection manner mutually, and the data lines and the scan lines intersect to form a plurality of pixel units;

wherein a frame amount value of “a”, a positive integer, including a plurality of frames constructs a frame set, the frame set includes at least one non-changed frame and at least one changed frame, and wherein when the LCD panel displays the non-changed frame, a plurality of polarities of pixel units keep constant, and when the LCD panel displays the changed frame, the polarities of pixel units of the LCD panel are changed.

In one embodiment, the frame amount value of “a” is selected from six to sixteen.

In one embodiment, the changed frame is arranged in a predetermined position of the frame set.

In one embodiment, each of the pixel units comprises a first pixel unit, for receiving a first data signal; and a second pixel unit, for receiving a second data signal.

In one embodiment, an amount of the first pixel unit is equal to an amount of the second pixel unit.

In one embodiment, the first pixel unit intersects with the second pixel unit.

In one embodiment, the pixel unit further comprises a thin film transistor and a pixel electrode, the thin film transistor comprises a gate electrode coupled to the scan lines, a source electrode coupled to the data lines, and a drain electrode coupled to the pixel electrode.

In one embodiment, the LCD panel further comprises a scan driving circuit and a data driving circuit wherein the scan driving circuit is coupled to the scan lines and the data driving circuit is coupled to the data lines.

In another embodiment, an active shutter three-dimensional (3D) LCD display apparatus, comprising:

a LCD panel; and

a shutter glass;

wherein the LCD panel comprises:

a plurality of parallel data lines; and

a plurality of parallel scan lines wherein the data lines and the scan lines are vertically arranged in an intersection manner mutually, and the data lines and the scan lines intersect to form a plurality of pixel units;

wherein a frame amount value of “a”, a positive integer, including a plurality of frames constructs a frame set, the frame set includes at least one non-changed frame and at least one changed frame, and wherein when the LCD panel displays the non-changed frame, a plurality of polarities of pixel units keep constant, and when the LCD panel displays the changed frame, the polarities of pixel units of the LCD panel are changed.

In one embodiment, the frame amount value of “a” is selected from six to sixteen.

In one embodiment, the changed frame is arranged in a predetermined position of the frame set.

In one embodiment, each of the pixel units comprises a first pixel unit, for receiving a first data signal; and a second pixel unit, for receiving a second data signal.

In one embodiment, an amount of the first pixel unit is equal to an amount of the second pixel unit.

In one embodiment, the first pixel unit intersects with the second pixel unit.

In one embodiment, the pixel unit further comprises a thin film transistor and a pixel electrode, the thin film transistor comprises a gate electrode coupled to the scan lines, a source electrode coupled to the data lines, and a drain electrode coupled to the pixel electrode.

In one embodiment, the 3D LCD display apparatus further comprises a scan driving circuit and a data driving circuit wherein the scan driving circuit is coupled to the scan lines and the data driving circuit is coupled to the data lines.

In one embodiment, the 3D LCD display apparatus further comprises a synchronous device for synchronously switching the shutter glass and a left-eye image frame and a right-eye image frame of the LCD panel.

The LCD display panel and active shutter three-dimensional (3D) LCD display apparatus of the present invention utilizes the non-changed frames and changed frames in the frame set by changing the polarities of the pixel units of each frame so that the pixel polarities between two frame in the pixel unit are switched to avoid the image sticking phenomenon and the 3D image crosstalk. Moreover, the brightness of the some left-eye image frame is higher and the brightness of the some left-eye image frame is lower. The present invention effectively reduces the brightness difference between the left-eye image frame and the right-eye image frame to improve the 3D image crosstalk phenomenon of the LCD panel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view of the conventional pixel polarity of the liquid crystal when the active shutter 3D LCD display apparatus employs dot inversion driving method to drive the pixels of the LCD panel;

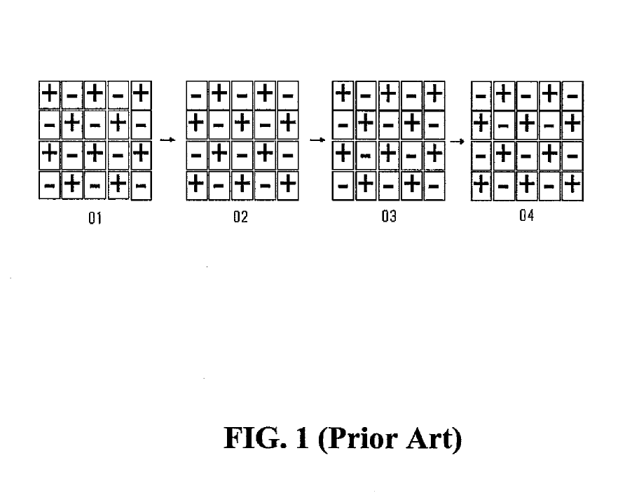

FIG. 2 is a schematic view of the conventional pixel polarity of the liquid crystal when the active shutter 3D LCD display apparatus employs dot inversion driving method in two frames to drive the pixels of the panel;

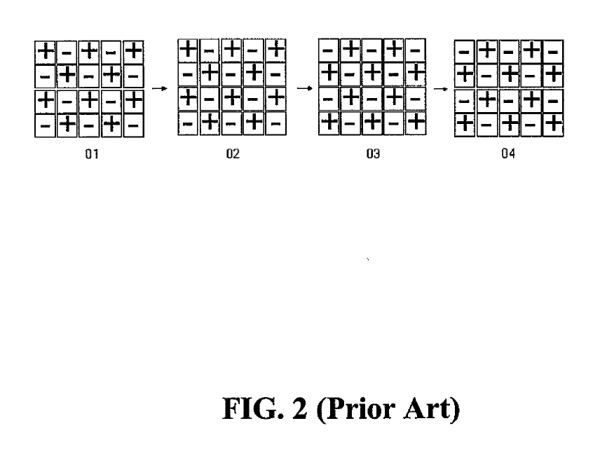

FIG. 3 is a schematic structural view of LCD panel according to the first embodiment of the present invention;

FIG. 4 is a schematic view of the pixel polarity of the liquid crystal when the active shutter 3D LCD display apparatus is operated according to the first embodiment of the present invention;

FIG. 5 is a schematic structural view of LCD panel according to the second embodiment of the present invention; and

FIG. 6 is a schematic view of the pixel polarity of the liquid crystal when the active shutter 3D LCD display apparatus is operated according to the second embodiment of the present invention.

### DETAILED DESCRIPTION OF THE PREFERRED EMBODIMENTS

The present invention provides a LCD display panel and an active shutter 3D LCD display apparatus to avoid the image sticking phenomenon and the 3D image crosstalk to solve the problem of the image sticking and the 3D image crosstalk.

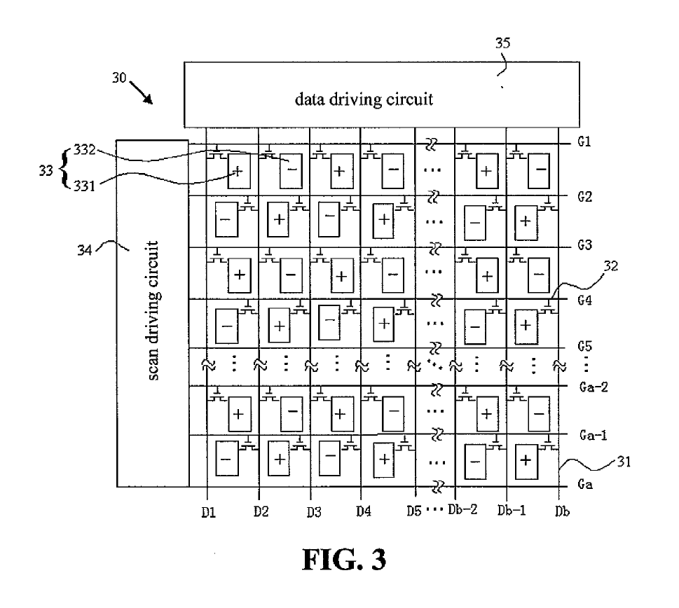

Please refer to FIG. 3. FIG. 3 is a schematic structural view of LCD panel 30 according to the first embodiment of the present invention. The LCD panel 30 includes a plurality of parallel data lines (D1 through Db) 31, a plurality of parallel scan lines (G1 through Ga) 32 wherein the data lines 31 and the scan lines 32 are vertically arranged in an intersection manner mutually. The data lines 31 and the scan lines 32 intersect to form a plurality of pixel units 33. When the LCD panel 30 is operated, the polarities of the pixel units 33 are circularly changed in form of each frame set. A frame amount value of “a” (positive integer) including a plurality of frames constructs a frame set wherein the frame amount value “a” is an arbitrary value, e.g. from 6 to 16. Each frame set includes at least one non-changed frame and at least one changed frame. In one case, if the frame amount value “a” is eight, the amount of non-changed frame is one and the amount of changed frame is seven. In another case, if the frame amount value “a” is sixteen, the amount of non-changed frame is one and the amount of changed frame is fifteen. In this case, when the LCD panel 30 displays the non-changed frame, the polarities of pixel units 33 of the LCD panel 30 keep constant, and when the LCD panel 30 displays the changed frames, the polarities of pixel units 33 of the LCD panel 30 are changed. In one embodiment, the non-changed frame is positioned in arbitrary location of the frame set and the changed frame is arranged in a predetermined position of the frame set for easily designing the driving circuit of the LCD panel 30.

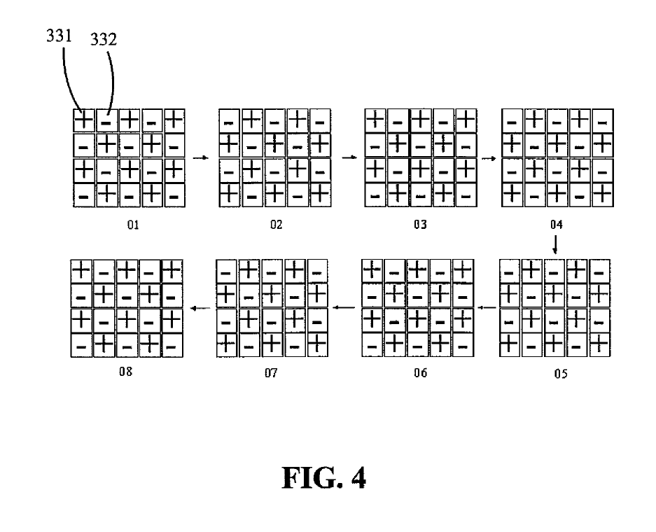

FIG. 3 and FIG. 4 illustrate the operation principle of the LCD panel in the present invention. FIG. 4 is a schematic view of the pixel polarity of the liquid crystal when the active shutter 3D LCD display apparatus is operated according to the first embodiment of the present invention.

In FIG. 3, the first pixel unit 331 intersects with the second pixel unit 332. In other words, a plurality of first pixel units 331 are positioned around one second pixel unit 332 and a plurality of second pixel units 332 are positioned around one first pixel unit 331. When the active shutter 3D LCD display apparatus is operated in FIG. 4, frame 01 through frame 08 are eight continuous frames forming a frame set. In this frame set, the odd frames are used to display the left-eye image frames and the even frames are used to display the right-eye image frames. The fifth frame of the frame set is non-changed frame and the rest of the frame set are changed frames.

The upper left pixel, i.e. first left-eye image frame, in the frame 01 of FIG. 4 is a pixel with positive polarity to display the left-eye data signal with positive polarity. The first right-eye image frame in the frame 02 of FIG. 4 is a pixel with negative polarity to display the right-eye data signal with negative polarity. The second left-eye image frame in the frame 03 of FIG. 4 is a pixel with positive polarity to display the left-eye data signal with positive polarity. The second right-eye image frame in the frame 04 of FIG. 4 is a pixel with negative polarity to display the right-eye data signal with negative polarity. The third left-eye image frame in the frame 05 of FIG. 4 is a pixel with negative polarity to display the left-eye data signal with negative polarity. The third right-eye image frame in the frame 06 of FIG. 4 is a pixel with positive polarity to display the right-eye data signal with positive polarity. The fourth left-eye image frame in the frame 07 of FIG. 4 is a pixel with negative polarity to display the left-eye data signal with negative polarity. The fourth right-eye image frame in the frame 08 of FIG. 4 is a pixel with positive polarity to display the right-eye data signal with positive polarity. Since the upper left pixel displays the positive polarities of the left-eye and right-eye data signals and the negative polarities of the left-eye and right-eye data signals during the eight continuous frames, the polarity of the pixel is advantageously changed or switched in the eight continuous frames to the image sticking effect even if the gray level of the left-eye image frame and the right-eye image frame is increased or decreased.

The pixel in the upper left of the frame of FIG. 4 is defined as the first pixel unit 331, i.e. the pixel with positive polarity is regarded as the first pixel unit 331. The pixel in the lower left of the frame of FIG. 4 is defined as the second pixel unit 332, i.e. the pixel with negative polarity is regarded as the second pixel unit 332. While displaying the frame 01, the first pixel unit 331 is the pixel with positive polarity and the second pixel unit 332 is the pixel with negative polarity. While displaying the frame 02, the first pixel unit 331 is the pixel with negative polarity and the second pixel unit 332 is the pixel with positive polarity. While displaying the frame 03, the first pixel unit 331 is the pixel with positive polarity and the second pixel unit 332 is the pixel with negative polarity. While displaying the frame 04, the first pixel unit 331 is the pixel with negative polarity and the second pixel unit 332 is the pixel with positive polarity. While displaying the frame 05, the first pixel unit 331 is the pixel with negative polarity and the second pixel unit 332 is the pixel with positive polarity. While displaying the frame 06, the first pixel unit 331 is the pixel with positive polarity and the second pixel unit 332 is the pixel with negative polarity. While displaying the frame 07, the first pixel unit 331 is the pixel with negative polarity and the second pixel unit 332 is the pixel with positive polarity. While displaying the frame 08, the first pixel unit 331 is the pixel with positive polarity and the second pixel unit 332 is the pixel with negative polarity.

While displaying the frame 01, the brightness of the first pixel unit 331 and the second pixel unit 332 is higher than a predetermined brightness. In this case, the polarity of the first pixel unit 331 is the same as that of the second pixel unit 332 in the frame 01 and frame 08 respectively. In other words, since the electric charges of the pixels are re-allocated, the brightness of the frame 01 is greater than that of the frame 08. While displaying the frame 02 through frame 04, the brightness of the pixel unit 33 is lower. While displaying the frame 05, the brightness of the pixel unit 33 is higher. While displaying the frame 06 through frame 08, the brightness of the pixel unit 33 is lower. In this case, the brightness of the frame 01 and frame 05 is higher and the rest are lower. That is, the brightness of the first left-eye image frame and the third left-eye image frame is higher, the brightness of the second left-eye image frame and the fourth left-eye image frame is lower, and the brightness of the first right-eye image frame through the fourth right-eye image frame is lower. On the contrary, the brightness of the right-eye image frame is always higher than that of the left-eye image frame, or the brightness of the left-eye image frame is always higher than that of the right-eye image frame. The present invention effectively reduces the brightness difference between the left-eye image frame and the right-eye image frame to improve the 3D image crosstalk phenomenon of the LCD panel.

In one preferred embodiment, the pixel unit 33 of the LCD panel 30 further includes a thin film transistor 333 and the pixel electrode 334. The thin film transistor 333 includes gate electrode coupled to the scan line 32, source electrode coupled to the data line 31, and drain electrode coupled to the pixel electrode 334. The thin film transistor 333 is positioned in pixel unit 33 and adjacent to the intersection of scan line 32 and the data line 31.

In one preferred embodiment, the LCD panel 30 further includes a scan driving circuit 34 and data driving circuit 35 wherein the scan driving circuit 34 is coupled to the scan line 32 and the data driving circuit 35 is coupled to the data line 31. The data driving circuit 35 controls a plurality of signal driving portions with different voltage polarities based on the output signal of the timing control circuit (not shown) so that the data lines 31 output data signals with different polarities when the various frames are controlled to be displayed.

The LCD display panel of the present invention utilizes the non-changed frames and changed frames in the frame set to avoid the image sticking phenomenon and the 3D image crosstalk.

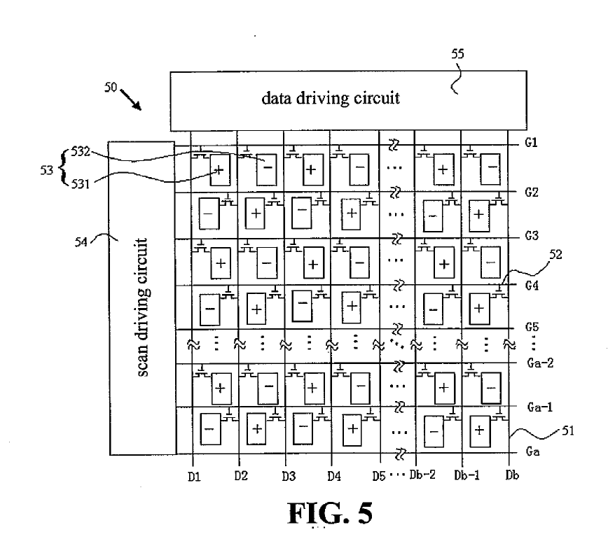

FIG. 5 is a schematic structural view of LCD panel according to the second embodiment of the present invention. The LCD panel 50 includes a plurality of parallel data lines (D1 through Db) 51, a plurality of parallel scan lines (G1 through Ga) 52 wherein the data lines 31 and the scan lines 32 are vertically arranged in an intersection manner mutually. The data lines 51 and the scan lines 52 intersect to form a plurality of pixel units 53. The LCD panel 50 in the second embodiment and the LCD panel 30 in the first embodiment is that each frame set includes sixteen frames in the LCD panel 50. The amount of non-changed frame is one and the amount of changed frame is fifteen. In this case, when the LCD panel 50 displays the non-changed frame, the polarities of pixel units 53 of the LCD panel 50 keep constant, and when the LCD panel 50 displays the changed frames, the polarities of pixel units 53 of the LCD panel 50 are changed. In one embodiment, the non-changed frame is positioned in arbitrary location of the frame set and the changed frame is arranged in a predetermined position of the frame set for easily designing the driving circuit of the LCD panel 50.

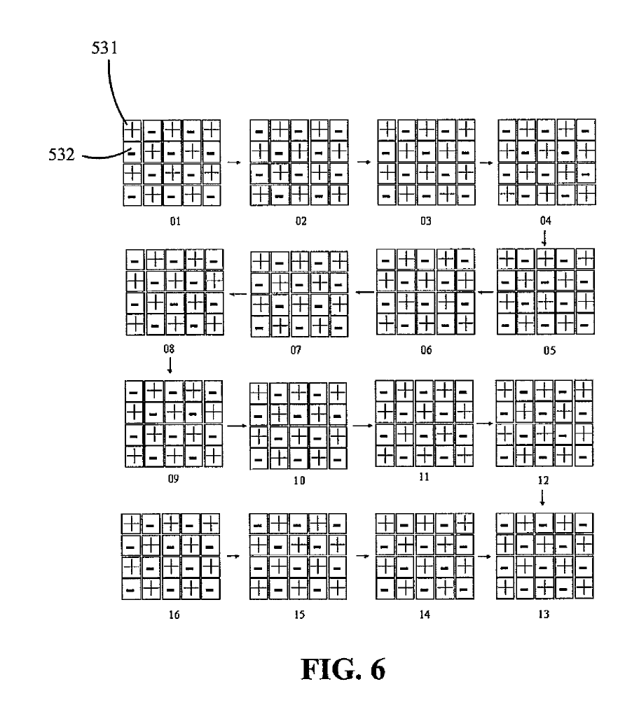

FIG. 5 and FIG. 6 illustrate the operation principle of the LCD panel in the present invention. FIG. 6 is a schematic view of the pixel polarity of the liquid crystal when the active shutter 3D LCD display apparatus is operated according to the second embodiment of the present invention.

In FIG. 6, the first pixel unit 531 intersects with the second pixel unit 532. In other words, a plurality of first pixel units 531 are positioned around one second pixel unit 532 and a plurality of second pixel units 532 are positioned around one first pixel unit 531. When the active shutter 3D LCD display apparatus is operated in FIG. 6, frame 01 through frame 16 are eight continuous frames forming a frame set. In this frame set, the odd frames are used to display the left-eye image frames and the even frames are used to display the right-eye image frames. The ninth frame of the frame set is non-changed frame and the rest of the frame set are changed frames. The upper left pixel, i.e. first left-eye image frame, in the frame 01 of FIG. 6 is a pixel with positive polarity to display the left-eye data signal with positive polarity. The first right-eye image frame in the frame 02 of FIG. 4 is a pixel with negative polarity to display the right-eye data signal with negative polarity. The fifth left-eye image frame in the frame 09 of FIG. 6 is a pixel with negative polarity to display the left-eye data signal with negative polarity. The fifth right-eye image frame in the frame 10 of FIG. 6 is a pixel with positive polarity to display the right-eye data signal with positive polarity. The eighth left-eye image frame in the frame 15 of FIG. 6 is a pixel with negative polarity to display the left-eye data signal with negative polarity. The eighth right-eye image frame in the frame 16 of FIG. 6 is a pixel with positive polarity to display the right-eye data signal with positive polarity. Since the upper left pixel displays the positive polarities of the left-eye and right-eye data signals and the negative polarities of the left-eye and right-eye data signals during the sixteen continuous frames, the polarity of the pixel is advantageously changed or switched in the sixteen continuous frames to the image sticking effect even if the gray level of the left-eye image frame and the right-eye image frame is increased or decreased.

The pixel in the upper left of the frame of FIG. 6 is defined as the first pixel unit 531, i.e. the pixel with positive polarity is regarded as the first pixel unit 531. The pixel in the second column and first row of the frame of FIG. 6 is defined as the second pixel unit 532, i.e. the pixel with negative polarity is regarded as the second pixel unit 532. While displaying the frame 01, the first pixel unit 531 is the pixel with positive polarity and the second pixel unit 532 is the pixel with negative polarity. While displaying the frame 02, the first pixel unit 531 is the pixel with negative polarity and the second pixel unit 532 is the pixel with positive polarity. While displaying the frame 07, the first pixel unit 531 is the pixel with positive polarity and the second pixel unit 532 is the pixel with negative polarity. While displaying the frame 08, the first pixel unit 531 is the pixel with negative polarity and the second pixel unit 532 is the pixel with positive polarity. While displaying the frame 09, the first pixel unit 531 is the pixel with negative polarity and the second pixel unit 532 is the pixel with positive polarity. While displaying the frame 10, the first pixel unit 531 is the pixel with positive polarity and the second pixel unit 532 is the pixel with negative polarity. While displaying the frame 15, the first pixel unit 531 is the pixel with negative polarity and the second pixel unit 532 is the pixel with positive polarity. While displaying the frame 16, the first pixel unit 531 is the pixel with positive polarity and the second pixel unit 532 is the pixel with negative polarity.

While displaying the frame 01, the brightness of the first pixel unit 331 and the second pixel unit 332 is higher than a predetermined brightness. In this case, the polarity of the first pixel unit 331 is the same as that of the second pixel unit 332 in the frame 01 and frame 16 respectively. In other words, since the electric charges of the pixels are re-allocated, the brightness of the frame 01 is greater than that of the frame 16. While displaying the frame 02 through frame 08, the brightness of the pixel unit 33 is lower. While displaying the frame 09, the brightness of the pixel unit 33 is higher. While displaying the frame 10 through frame 16, the brightness of the pixel unit 33 is lower. In this case, the brightness of the frame 01 and frame 09 is higher and the rest are lower. That is, the brightness of the first left-eye image frame and the fifth left-eye image frame is lower, the brightness of the second, third, fourth, sixth, seventh and eighth left-eye image frames are lower, and the brightness of the first right-eye image frame through the eighth right-eye image frame is lower. On the contrary, the brightness of the right-eye image frame is always higher than that of the left-eye image frame, or the brightness of the left-eye image frame is always higher than that of the right-eye image frame. The present invention effectively reduces the brightness difference between the left-eye image frame and the right-eye image frame to improve the 3D image crosstalk phenomenon of the LCD panel.

In one preferred embodiment, the pixel unit 53 of the LCD panel 50 further includes a thin film transistor 533 and the pixel electrode 534. The thin film transistor 533 includes gate electrode coupled to the scan line 52, source electrode coupled to the data line 51, and drain electrode coupled to the pixel electrode 534. The thin film transistor 533 is positioned in pixel unit 53 and adjacent to the intersection of scan line 52 and the data line 51.

In one preferred embodiment, the LCD panel 50 further includes a scan driving circuit 54 and data driving circuit 55 wherein the scan driving circuit 54 is coupled to the scan line 52 and the data driving circuit 55 is coupled to the data line 51. The data driving circuit 55 controls a plurality of signal driving portions with different voltage polarities based on the output signal of the timing control circuit (not shown) so that the data lines 51 output data signals with different polarities when the various frames are controlled to be displayed.

The LCD display panel of the present invention utilizes the non-changed frames and changed frames in the frame set to avoid the image sticking phenomenon and the 3D image crosstalk.

The present invention provides an active shutter three-dimensional (3D) LCD display apparatus. The active shutter three-dimensional (3D) LCD display apparatus includes the LCD display panel, shutter glass and the synchronous device. The LCD display panel is used to display the left-eye image frame and the right-eye image frame. The shutter glass combines the left-eye image frame and the right-eye image frame of the LCD display panel as 3D image frame. The synchronous device is used to synchronously to switch the shutter glass and the left-eye image frame and the right-eye image frame of the LCD display panel.

The LCD display panel and active shutter three-dimensional (3D) LCD display apparatus of the present invention utilizes the non-changed frames and changed frames in the frame set by changing the polarities of the pixel units of each frame so that the pixel polarities between two frame in the pixel unit are switched to avoid the image sticking phenomenon and the 3D image crosstalk. Moreover, the brightness of the some left-eye image frame is higher and the brightness of the some left-eye image frame is lower. The present invention effectively reduces the brightness difference between the left-eye image frame and the right-eye image frame to improve the 3D image crosstalk phenomenon of the LCD panel.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A liquid crystal display (LCD) panel, comprising:
a plurality of parallel data lines; and
a plurality of parallel scan lines wherein the data lines and the scan lines are vertically arranged in an intersection manner mutually, and the data lines and the scan lines intersect to form a plurality of pixel units;
wherein a frame amount value of “a”, a positive integer, including a plurality of frames constructs a frame set, the frame set includes at least one non-changed frame and at least one changed frame, and wherein when the LCD panel displays the non-changed frame, a plurality of polarities of pixel units keep constant, and when the LCD panel displays the changed frame, the polarities of pixel units of the LCD panel are changed.

2. The LCD panel of claim 1, wherein the frame amount value of “a” is selected from six to sixteen.

3. The LCD panel of claim 1, wherein the changed frame is arranged in a predetermined position of the frame set.

4. The LCD panel of claim 1, wherein each of the pixel units comprises:
a first pixel unit, for receiving a first data signal; and
a second pixel unit, for receiving a second data signal.

5. The LCD panel of claim 4, wherein an amount of the first pixel unit is equal to an amount of the second pixel unit.

6. The LCD panel of claim 4, wherein the first pixel unit intersects with the second pixel unit.

7. The LCD panel of claim 1, wherein the pixel unit further comprises a thin film transistor and a pixel electrode, the thin film transistor comprises a gate electrode coupled to the scan lines, a source electrode coupled to the data lines, and a drain electrode coupled to the pixel electrode.

8. The LCD panel of claim 1, further comprising a scan driving circuit and a data driving circuit wherein the scan driving circuit is coupled to the scan lines and the data driving circuit is coupled to the data lines.

9. An active shutter three-dimensional (3D) LCD display apparatus, comprising:
a LCD panel; and
a shutter glass;
wherein the LCD panel comprises:
a plurality of parallel data lines; and
a plurality of parallel scan lines wherein the data lines and the scan lines are vertically arranged in an intersection manner mutually, and the data lines and the scan lines intersect to form a plurality of pixel units;
wherein a frame amount value of “a”, a positive integer, including a plurality of frames constructs a frame set, the frame set includes at least one non-changed frame and at least one changed frame, and wherein when the LCD panel displays the non-changed frame, a plurality of polarities of pixel units keep constant, and when the LCD panel displays the changed frame, the polarities of pixel units of the LCD panel are changed.

10. The 3D LCD display apparatus of claim 9, wherein the frame amount value of “a” is selected from six to sixteen.

11. The 3D LCD display apparatus of claim 9, wherein the changed frame is arranged in a predetermined position of the frame set.

12. The 3D LCD display apparatus of claim 9, wherein each of the pixel units comprises:
a first pixel unit, for receiving a first data signal; and
a second pixel unit, for receiving a second data signal.

13. The 3D LCD display apparatus of claim 12, wherein an amount of the first pixel unit is equal to an amount of the second pixel unit.

14. The 3D LCD display apparatus of claim 12, wherein the first pixel unit intersects with the second pixel unit.

15. The 3D LCD display apparatus of claim 9, wherein the pixel unit further comprises a thin film transistor and a pixel electrode, the thin film transistor comprises a gate electrode coupled to the scan lines, a source electrode coupled to the data lines, and a drain electrode coupled to the pixel electrode.

16. The 3D LCD display apparatus of claim 9, further comprising a scan driving circuit and a data driving circuit wherein the scan driving circuit is coupled to the scan lines and the data driving circuit is coupled to the data lines.

17. The 3D LCD display apparatus of claim 9, further comprising a synchronous device for synchronously switching the shutter glass and a left-eye image frame and a right-eye image frame of the LCD panel.
